(19) United States
(12) Patent Application Publication
(10) Pub. No.: US 2026/0225294 A1
(43) Pub. Date: Aug. 6, 2026

(54) METAL LAMINATE-POLYMER RESIN COMPOSITE AND METHOD OF MANUFACTURING THE SAME

(71) Applicant: DYP CO., LTD., Ansan-si (KR)

(72) Inventors: Zuojia WANG, Ansan-si (KR); Hyeokchul YANG, Ansan-si (KR); Seongyean HWANG, Ansan-si (KR); Juhyun SUN, Ansan-si (KR); Mijeong MUN, Ansan-si (KR); Sang Chul SON, Ansan-si (KR)

(21) Appl. No.: 19/042,609

(22) Filed: Jan. 31, 2025

(51) Int. Cl. B29C 45/00; B29C 45/14; B29K 81/00; B29K 105/20; B29K 705/02; B29K 705/10; B29L 31/34

(52) U.S. Cl. CPC B29C 45/0001; B29C 45/14639; B29C 45/14819; B29C 2045/14868; B29C 2945/76525; B29C 2945/76531; B29K 2081/04; B29K 2105/20; B29K 2705/02; B29K 2705/10; B29K 2995/0097; B29K 2995/0098; B29L 2031/3406

(57) ABSTRACT

Provided is a method of preparing a metal laminate-polymer resin composite including a metal laminate formed of copper and aluminum laminated therein; and a polymer resin. According to an embodiment of the present disclosure, the method includes an electrolytic oxidation step of electrolytically oxidizing the metal laminate in a solution for electrolytic oxidation to form a first porous oxide film having a roughened structure on a surface of the aluminum; an electroless oxidation step of performing electroless oxidation for the metal laminate in a solution for electroless oxidation to form a second porous oxide film having a roughened structure on a surface of the copper; and a bonding step of bonding the metal laminate with the polymer resin.

### BACKGROUND OF THE DISCLOSURE

### Field of the Disclosure

The present disclosure relates to a metal laminate-polymer resin composite and a method of manufacturing the same, and more particularly to a metal laminate-polymer resin composite in which a metal laminate composed of copper and aluminum laminated therein is bonded to a polymer resin; and a method of manufacturing the metal laminate-polymer resin composite.

### Description of the Related Art

A metal-polymer resin composite is manufactured by bonding a metal with a polymer resin which are different materials. This metal-polymer resin composite has the advantage of being able to implement both the characteristics of metal and the characteristics of polymer resin. The metal-polymer resin composite can be applied to various industrial fields such as automobiles, various electronic devices, and secondary batteries.

Insert injection can be used as a method of manufacturing a metal-polymer resin composite. For example, by loading metal parts spaced apart from each other by a certain distance into a mold of an insert injection machine, and then injecting a molten polymer resin into the mold to fill the space between the metal parts and then performing solidification, a structure in which metal parts mechanically bonded to each other while being electrically insulated can be manufactured.

Metals used in metal-polymer resins may include copper and aluminum which have excellent electrical properties. For example, copper and aluminum can be used as electrode terminals for electrical and electronic products due to their excellent electrical conductivity properties. As the material of the electrode terminals, copper or aluminum is used alone, but if necessary, a metal laminate formed of copper and aluminum laminated therein can be used.

A copper-aluminum laminate formed by laminating copper and aluminum can be manufactured by, for example, placing aluminum on at least one surface of copper and then physically, thermally, or chemically bonding them to each other. Typically, copper-aluminum laminates can be manufactured by a cladding process. The cladding process is a method of manufacturing a single composite metal structure by overlapping different metals and then pressing them together using a high-pressure roller or welding them by applying heat to form a strong bond at the interface between the metals. This metal laminate can implement functions, which cannot be implemented when the laminate is made of only a single metal, because metals that constitute the laminate perform different functions.

To electrically insulate an electrode terminal from its surroundings in an electrical and electronic product, at least a portion of an electrode terminal may be surrounded by a polymer resin, which is an insulator, and then the electrode terminal and the polymer resin may be bonded to each other. When the electrode terminal is a metal laminate formed of copper and aluminum laminated therein, a copper-polymer resin bond is formed in the copper portion of the electrode terminal, and an aluminum-polymer resin bond is formed in the aluminum portion thereof. Metal and polymer resin are fundamentally different materials with different chemical bond states, so it is difficult to achieve high bonding strength at their bonding interface. Furthermore, since the electrode terminal is made of copper and aluminum, which are of the same metal material but have different chemical properties, there is a difficulty in ensuring that both the copper-polymer resin bond and the aluminum-a polymer resin bond satisfy excellent bonding strength at the same time.

### SUMMARY OF THE DISCLOSURE

Therefore, the present disclosure has been made in view of the above problems, and it is an object of the present disclosure to provide a metal laminate-polymer resin composite: including a metal laminate formed of copper and aluminum laminated therein; and a polymer resin, wherein excellent bonding strength is exhibited both at the interface between the aluminum and the polymer resin and at the interface between the copper and the polymer resin, and a method of manufacturing the metal laminate-polymer resin composite. It will be understood that the technical problems are only provided as examples, and the scope of the present disclosure is not limited thereto.

In accordance with an aspect of the present disclosure, the above and other objects can be accomplished by the provision of a method of preparing a metal laminate-polymer resin composite, the metal laminate-polymer resin composite comprising: a metal laminate formed of copper and aluminum laminated therein and a polymer resin.

According to an embodiment of the present disclosure, the method includes: a degreasing step of degreasing a surface of the metal laminate; an electrolytic oxidation step of electrolytically oxidizing the metal laminate in a solution for electrolytic oxidation to form a first porous oxide film having a roughened structure on a surface of the aluminum; an electroless oxidation step of performing electroless oxidation for the metal laminate in a solution for electroless oxidation to form a second porous oxide film having a roughened structure on a surface of the copper; and a bonding step of bonding the metal laminate with the polymer resin.

According to an embodiment of the present disclosure, the solution for electrolytic oxidation may be an acidic solution prepared by mixing two or more acids selected from oxalic acid (C₂H₂O₄), phosphoric acid (H₃PO₄), chromic acid (H₂CrO₄), citric acid (C₆H₈O₇) and sulfuric acid (H₂SO₄) with water.

According to an embodiment of the present disclosure, the solution for electroless oxidation may be a mixed solution prepared by dissolving two or more substances selected from sodium sulfate, sodium hydroxide, sodium chlorate, sodium chlorite and sodium phosphate in water.

According to an embodiment of the present disclosure, a sum of the concentrations of the two or more acids comprised in the solution for electrolytic oxidation may be 1 to 35 wt %.

According to an embodiment of the present disclosure, a concentration of each of the two or more acids comprised in the solution for electrolytic oxidation may be 1 wt % or more and less than 20 wt %.

According to an embodiment of the present disclosure, the first oxide film may have a thickness of 50 to 800 nm.

According to an embodiment of the present disclosure, a sum of concentrations of the two or more substances contained in the solution for electroless oxidation may be 1 to 50 wt %.

According to an embodiment of the present disclosure, a concentration of each of the two or more substances contained in the solution for electroless oxidation may be 1 wt % or more and less than 30 wt %.

According to an embodiment of the present disclosure, the second oxide film may have a thickness of 50 to 800 nm.

According to an embodiment of the present disclosure, in the electrolytic oxidation step, a current density applied to the metal laminate, which is a positive electrode, may be 0.5 to 50 A/dm².

According to an embodiment of the present disclosure, in the electrolytic oxidation step and the electroless oxidation step, the solution for electrolytic oxidation and the solution for electroless oxidation may have a temperature of 20 to 80° C.

According to an embodiment of the present disclosure, the polymer resin may include one of polyphenylene sulfide, polybutylene terephthalate, liquid crystal polymers, polyether ether ketone, polyphthalamide, polyamide, polycarbonate and polypropylene.

According to an embodiment of the present disclosure, in the degreasing step, a degreasing solution may include ionic water.

In accordance with another aspect of the present disclosure, provided is a metal laminate-polymer resin composite.

According to an embodiment of the present disclosure, the metal laminate-polymer resin composite includes a metal laminate formed of copper and aluminum laminated therein; and a polymer resin bonded to at least a part of the copper and at least a part of the aluminum.

According to an embodiment of the present disclosure, a first porous oxide film having a roughened structure may be formed on a surface of the aluminum bonded to the polymer resin, and a second porous oxide film having a roughened structure may be formed on a surface of the copper bonded to the polymer resin.

According to an embodiment of the present disclosure, the first oxide film may have a thickness of 50 to 800 nm.

According to an embodiment of the present disclosure, the second oxide film may have a thickness of 50 to 800 nm.

According to an embodiment of the present disclosure, a bonding strength between the metal laminate and the polymer resin may be 40 MPa or more.

According to an embodiment of the present disclosure, the polymer resin may include one of polyphenylene sulfide, polybutylene terephthalate, liquid crystal polymers, polyether ether ketone, polyphthalamide, polyamide, polycarbonate and polypropylene.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a method of manufacturing a metal laminate-polymer resin according to an embodiment of the present disclosure step by step;

FIGS. 2 and 3 illustrate the cross-section of the surface of metal laminate of Example 1 observed using an electron microscope; and

FIGS. 4 and 5 illustrate the cross-section of the surface of metal laminate of Comparative Example 6 observed using an electron microscope.

### DETAILED DESCRIPTION OF THE DISCLOSURE

Hereinafter, one or more preferred embodiments of the present disclosure will be described in detail with reference to the accompanying drawings. Embodiments of the present disclosure are provided to more completely explain the present disclosure to those skilled in the art, and the following embodiments may be modified in many different forms, but the scope of the present disclosure is not limited to the following embodiments. Rather, the embodiments are provided to make the disclosure thorough and complete and to fully convey the technical idea of the disclosure to those skilled in the art.

In this specification and the accompanying claims, a composite of a metal laminate, formed of laminated copper and aluminum, and a polymer resin refers to “metal laminate-polymer resin composite.” In addition, in this specification and the accompanying claims, copper refers to both pure copper and copper alloys, and aluminum refers to both pure aluminum and aluminum alloys.

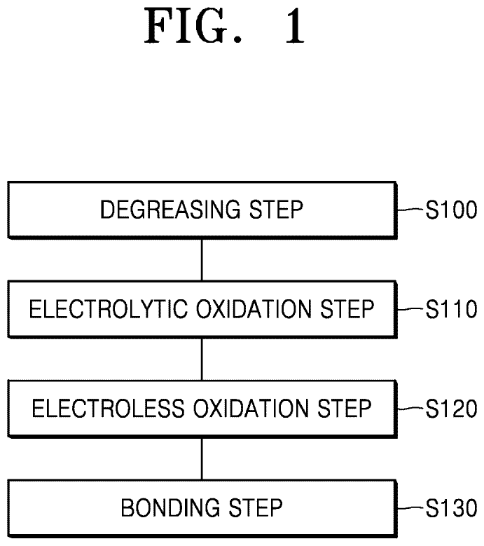

FIG. 1 illustrates a method of manufacturing a metal laminate-polymer resin according to an embodiment of the present disclosure step by step. The manufacturing method of the metal laminate-polymer resin composite includes a surface treatment step for the metal laminate, which comprises a degreasing step (S100), an electrolytic oxidation step (S110), and an electroless oxidation step (S120), and a bonding step (S130) of bonding the surface-treated metal laminate with a polymer resin.

Referring to FIG. 1, the degreasing step (S100) of degreasing the surface of the metal laminate to be bonded to a polymer resin is performed. The degreasing step is a step of removing various impurities including oil present on the surface of the metal laminate using a degreasing solution. The metal laminate may be degreased by being immersed in a container containing a degreasing solution for a predetermined time. Alternatively, the surface of metal laminate may be degreased by spraying the degreasing solution onto the metal laminate using a nozzle, etc.

To increase the efficiency of degreasing, ultrasonic treatment for degreasing may be performed while supplying ultrasonic waves using an ultrasonic cleaning device. For example, the metal laminate may be immersed in a degreasing solution, and degreasing can be performed by applying ultrasonic waves to the metal laminate immersed in the degreasing solution using an ultrasonic cleaning device.

The degreasing solution used in the degreasing step (S100) may include ionic water. Ionic water is water that has been electrolytically treated with distilled water, and may include acidic ionic water or alkaline ionic water.

Next, the electrolytic oxidation step (S110) of electrolytically oxidizing the metal laminate that had undergone the degreasing step (S100) in an electrolytic bath is performed. The electrolytic oxidation step (S110) is a step in which the metal laminate is immersed in an electrolytic bath containing an electrolytic solution, and then aluminum in the metal laminate is set as a positive electrode, an insoluble electrode is set as a negative electrode, and then a predetermined current is applied to the positive electrode to electrolytically oxidize (or anodically oxidize) the surface of the aluminum that is a positive electrode.

The solution for electrolytic oxidation includes an acidic solution prepared by mixing two or more types of acids with water, such as distilled water. The acid that constitutes that acidic solution is a mixture of two or more selected from oxalic acid (C₂H₂O₄), phosphoric acid (H₃PO₄), chromic acid (H₂CrO₄), citric acid (C₆H₈O₇) and sulfuric acid (H₂SO₄). For example, the acidic solution may be prepared by mixing oxalic acid, phosphoric acid and sulfuric acid with distilled water.

The concentration of the acid in the entire solution for electrolytic oxidation may be 1 to 35 wt %. In addition, the concentration of each of the two types of acids contained in the solution for electrolytic oxidation may be 1 wt % or more and less than 20 wt %, preferably 2 to 15 wt %.

The temperature of the solution for electrolytic oxidation during electrolytic oxidation may range from 20 to 80° C., a voltage applied to the positive electrode may range from 0.2 to 30V, the current density may range from 0.5 to 50 A/dm², and the electrolytic oxidation may be performed for 30 to 600 sec.

In the electrolytic oxidation step (S110), a porous anodized film having a roughened structure is formed on the aluminum surface. This is called a first oxide film. As the first porous oxide film with a roughened structure is formed on the aluminum surface, the roughness of the aluminum surface increases, and accordingly, the area of the aluminum surface which bonds with the polymer resin increases. In addition, the roughened structure plays a role in mechanically interlocking the aluminum and the polymer resin when they are bonded, and in the bonded state, the roughened structure can disperse the force transmission to make the bond more solid, and can prevent the slipping between the aluminum and the polymer resin by increasing the frictional force and the fixing force. In addition, the bonding force may be improved by increasing the bonding area between the aluminum and the polymer resin due to an increase in the area of the aluminum surface.

The first oxide film formed on the aluminum surface may act as a bonding layer to increase the bonding force between the aluminum and the polymer resin. Accordingly, the first oxide film may be referred to as a first bonding layer. The first oxide film may have a thickness of 50 to 800 nm, preferably 200 to 600 nm, more preferably 400 to 600 nm.

The solution for electrolytic oxidation used in the electrolytic oxidation step is a solution for the electrolytic oxidation of aluminum, and accordingly, the electrolytic oxidation of copper in the metal laminate does not substantially occur in the electrolytic oxidation step.

After the electrolytic oxidation step (S110) is completed, the electroless oxidation step (S120) is performed. The electroless oxidation step (S120) is a step in which the metal laminate is immersed in the solution for electroless oxidation and then a copper oxide film is formed on the copper surface of the metal laminate by a chemical reaction.

The solution for electroless oxidation may be a mixed solution prepared by dissolving two or more substances selected from sodium sulfate (Na₂SO₄), sodium hydroxide (NaOH), sodium chlorate (NaClO₃), sodium chlorite (NaClO₂) and sodium phosphate (Na₃PO₄) in water.

The total content of the substances in the solution for electroless oxidation may be 1 to 50 wt %, preferably 5 to 30 wt %. In addition, the concentration of each of the two or more substances contained in the solution for electroless oxidation may be 1 wt % or more and less than 30 wt %.

The temperature of the solution for electroless oxidation during electroless oxidation may be 20 to 80° C., and the electroless oxidation may be performed for 30 to 600 sec.

Also in the electroless oxidation step (S120), a porous oxide film having a roughened structure is formed on the copper surface. This is called a second oxide film. The second oxide film functions as a bonding layer that increases the bonding force of the polymer resin, and since this effect is substantially the same as the function of the first oxide film described above, its description is omitted. The second oxide film may be called a second bonding layer. The thickness of the second oxide film may range from 50 to 800 nm, preferably from 100 to 500 nm, more preferably from 200 to 400 nm.

The solution used in the electroless oxidation step (S120) is a solution for the electroless oxidation of copper, and accordingly, the electroless oxidation of aluminum in the metal laminate does not occur in the electroless oxidation step (S120). Accordingly, the structure of the porous anodized film with a roughened structure formed on the surface of the aluminum in the electrolytic oxidation step (S110) is not affected.

After completing the surface treatment for the metal laminate, a bonding step (S130) of bonding the metal laminate with the polymer resin is performed. The bonding step (S130) may include, for example, an insert injection step. In the case of insert injection, the surface-treated metal laminate is loaded into a mold of an insert injection machine and then fixed. Next, when a molten polymer resin is injected into the mold, the high-temperature molten polymer resin is solidified while surrounding the metal laminate. When the solidification is completed, a metal laminate-polymer resin composite in which at least a portion of the surface of the metal laminate is bonded to the polymer resin is formed. At least a portion of the copper surface and at least a portion of the aluminum surface of the metal laminate may be bonded to the polymer resin. When the insert injection process is completed, the mold is removed to obtain a metal laminate-polymer resin composite. The bonding by such insert injection is one example, and the bonding method of the present disclosure is not limited thereto.

The polymer resin may include one of polyphenylene sulfide, polybutylene terephthalate, liquid crystal polymers, polyether ether ketone, polyphthalamide, polyamide, polycarbonate and polypropylene.

When the surface treatment for the metal laminate according to an embodiment of the present disclosure is performed as described above, a porous oxide film of a roughened structure is formed on both the surfaces of the copper and aluminum constituting the metal laminate. This porous oxide film acts as a bonding layer, and accordingly, the presence of this bonding layer may cause excellent bonding force properties between the metal laminate and the polymer resin. For example, the bonding strength of the metal laminate-polymer resin composite may be 40 MPa or more.

The technology for forming such a metal laminate-polymer resin composite may be applied, for example, to the manufacture of a cap plate assembly used in lithium battery cells for secondary batteries. The cap plate assembly is a component installed in a housing opening of the battery cell and used to cover and seal the opening of the housing. The cap plate assembly includes a cap plate using a metal material, for example, aluminum, and an electrode terminal using a copper-aluminum metal laminate. The electrode terminal may be placed in a hole penetrating a cap plate, and in this case, a polymer resin as an insulator may be formed between the cap plate and an electrode terminal by insert injection. Accordingly, at least a part of the electrode terminal surface is bonded to the polymer resin to form a composite. The interface between the electrode terminal and the polymer resin in the cap plate should have high bonding strength and excellent sealing characteristics to effectively seal the leakage of a battery electrolyte contained in the cell. When performing the surface treatment according to one embodiment of the present disclosure on the metal laminate electrode terminal, excellent bonding characteristics may be exhibited at the interface between both the aluminum and copper in the metal laminate and the polymer resin, so that the electrode terminal may be stably fixed within the cap plate while obtaining sufficient sealing characteristics and electrical insulation characteristics.

### EXPERIMENTAL EXAMPLES

Hereinafter, a desirable experimental example is presented to help understand the present disclosure. However, the experimental example below is only to help understand the present disclosure, and the present disclosure is not limited to the experimental example below.

A plurality of copper-aluminum laminates manufactured by bonding copper plates and aluminum plates in a cladding process were prepared as metal laminates.

All of the prepared copper-aluminum laminates were subjected to a degreasing step using ultrasonic waves in ionic water. The metal laminates that had undergone the degreasing step were subjected to an electrolytic oxidation step and an electroless oxidation step. The metal laminates that had undergone the electrolytic oxidation step and the electroless oxidation step were used to manufacture metal laminate-polymer resin composites using an insert injection machine. Polyphenylene sulfide was used as the polymer resins.

In the manufactured metal laminate-polymer resin composites, a part of the interface between the metal laminate and the polymer resin was the interface between the aluminum and the polymer resin, and the remainder was the interface between the copper and the polymer resin.

Table 1 shows the types and concentrations of acids contained in the solutions for electrolytic oxidation and the types, and concentrations of substances contained in the solutions for electroless oxidation which correspond to the examples and the comparative examples. The compositions of the components constituting the solutions for electrolytic oxidation and the solutions for electroless oxidation are expressed as wt % of the entire solution.

TABLE 1

| | Solution for electrolytic | solution for electroless |
|---|---|---|
| Specimen | oxidation | oxidation |
| Example 1 | Oxalic acid 10 wt % | Sodium hydroxide 5 wt % |
| | Phosphoric acid 7 wt % | Sodium chlorite 10 wt % |
| | Sulfuric acid 3 wt % | Sodium phosphate 10 wt % |
| Example 2 | Oxalic acid 5 wt % | Sodium hydroxide 5 wt % |
| | Phosphoric acid 5 wt % | Sodium chlorite 10 wt % |
| | Sulfuric acid 10 wt % | Sodium phosphate 15 wt % |
| Example 3 | Oxalic acid 2 wt % | Sodium hydroxide 5 wt % |
| | Phosphoric acid 3 wt % | Sodium chlorite 15 wt % |
| | Sulfuric acid 15 wt % | Sodium phosphate 10 wt % |
| Comparative | Oxalic acid 20 wt % | Sodium hydroxide 5 wt % |
| Example 1 | Phosphoric acid 15 wt % | Sodium chlorite 10 wt % |
| | Sulfuric acid 10 wt % | Sodium phosphate 10 wt % |
| Comparative | Oxalic acid 5 wt % | Sodium hydroxide 10 wt % |
| Example 2 | Phosphoric acid 5 wt % | Sodium chlorite 20 wt % |
| | Sulfuric acid 10 wt % | Sodium phosphate 30 wt % |
| Comparative | Oxalic acid 2 wt % | Sodium hydroxide 10 wt % |
| Example 3 | Phosphoric acid 10 wt % | Sodium chlorite 30 wt % |
| | Sulfuric acid 30 wt % | Sodium phosphate 20 wt % |
| Comparative | Oxalic acid 20 wt % | Sodium hydroxide 25 wt % |
| Example 4 | | |
| Comparative | Phosphoric acid 20 wt % | Sodium chlorite 25 wt % |
| Example 5 | | |
| Comparative | Sulfuric acid 20 wt % | Sodium phosphate 25 wt % |
| Example 6 | | |

Referring to Table 1, all of the solutions for electrolytic oxidation of Examples 1 to 3 were mixed acidic solutions in which oxalic acid, phosphoric acid and sulfuric acid were mixed with distilled water. In Examples 1 to 3, each of oxalic acid, phosphoric acid and sulfuric acid showed a composition range of less than 20 wt %. In addition, the total composition of oxalic acid, phosphoric acid and sulfuric acid was 20 wt %, which was less than 35 wt %, for the entire mixed solution.

Examining the solutions for electrolytic oxidation of the comparative examples, all of Comparative Examples 1 to 3 were mixed acidic solutions prepared by mixing oxalic acid, phosphoric acid, and sulfuric acid. However, Comparative Examples 1 and 3 in which all of oxalic acid, phosphoric acid and sulfuric acid were combined, showed 45 wt % and 42 wt %, respectively, both of which showed values exceeding 35 wt %. In addition, the concentration of oxalic acid in Comparative Example 1 was 20 wt %, and the concentration of sulfuric acid in Comparative Example 3 was 30 wt %, both of which showed values of 20 wt % or more.

Meanwhile, the solutions for electrolytic oxidation of Comparative Examples 4 to 6 were prepared by mixing only one acid with distilled water. Specifically, the solution for electrolytic oxidation of Comparative Example 4 was prepared by mixing only oxalic acid with distilled water, the solution for electrolytic oxidation Comparative Example 5 was prepared by mixing only phosphoric acid with distilled water, and the solution for electrolytic oxidation Comparative Example 6 was prepared by mixing only sulfuric acid with distilled water. In all of the acidic solutions of Comparative Examples 1 to 3, the concentration of the acid was 20 wt %.

Referring to Table 1, all of the electroless solutions of Examples 1 to 3 were mixed solutions in which sodium hydroxide, sodium chlorite, and sodium phosphate were dissolved in distilled water. In Examples 1 to 3, each of sodium hydroxide, sodium chlorite, and sodium phosphate had a composition range of 1 wt % or more and less than 30 wt %, and the total composition of sodium hydroxide, sodium chlorite, and sodium phosphate was 20 wt % of the total mixed solution, which is less than 50 wt %.

On the other hand, examining the electroless solutions corresponding to the comparative examples, all of Comparative Examples 1 to 3 were mixed solutions in which sodium hydroxide, sodium chlorite, and sodium phosphate were dissolved in distilled water. However, in the case of the composition containing all of sodium hydroxide, sodium chlorite, and sodium phosphate, all of Comparative Examples 1 to 3 showed 60 wt % which exceeds 50 wt %.

Meanwhile, the solutions for electroless oxidation of Comparative Examples 4 to 6 were solutions in which only one substance was mixed with distilled water. Comparative Example 4 was a solution in which only sodium hydroxide was mixed with distilled water, Comparative Example 5 was a solution in which only sodium chlorite was mixed with distilled water, and Comparative Example 6 was a solution in which only sodium phosphate was mixed with distilled water. In all of Comparative Examples 4 to 6, the concentration of substances in the solution was 25 wt %.

Table 2 shows the process conditions of the electrolytic oxidation step and an electroless oxidation step for specimens corresponding to the examples and comparative examples shown in Table 1. The electrolytic oxidation and electroless oxidation for the examples and the comparative examples were performed under conditions shown in Table 2 below.

TABLE 2

| | Temperature | Voltage | Current density | Time |
|---|---|---|---|---|
| Process Step | (° C.) | (V) | (A/dm²) | (sec) |
| Electrolytic | 70 | 6 | 10 | 120 |
| oxidation | | | | |
| Electroless | 60 | — | 0 | 90 |
| oxidation | | | | |

Table 3 shows the properties of the metal laminate-polymer resin composites of the examples and the comparative examples. Referring to Table 3, the first bonding layer thickness refers to the thickness of the first oxide film formed on the aluminum surface in the electrolytic oxidation step, and the second bonding layer thickness refers to the thickness of the second oxide film formed on the copper surface in the electroless oxidation step. The thickness of each of the first bonding layer and the second bonding layer was measured by observing the cross-section of the surface of the metal laminate using an electron microscope after completing the electrolytic oxidation step and the electroless oxidation step.

For sealability evaluation, the helium leak pressure was measured to confirm the sealability between the metal laminate and the polymer resin. When the helium leak pressure was less than 0.003 bar, it was marked as O, and when the helium leak pressure was 0.003 bar or more, it was marked as X.

The bonding strength refers to the bonding strength between the metal laminate and polymer resin, which was measured as the tensile fracture strength between the metal laminate and polymer resin using a tensile tester.

TABLE 3

| | First bonding | Second bonding | | Bonding |
|---|---|---|---|---|
| | layer thickness | layer thickness | Sealability | strength |
| Specimen | (nm) | (nm) | evaluation | (MPa) |
| Example 1 | 460 | 210 | ◯ | 43 |
| Example 2 | 510 | 330 | ◯ | 52 |
| Example 3 | 570 | 320 | ◯ | 46 |
| Comparative | 1300 | 225 | X | 22 |
| Example 1 | | | | |
| Comparative | 280 | 30 | X | 17 |
| Example 2 | | | | |
| Comparative | 1450 | 20 | X | 13 |
| Example 3 | | | | |
| Comparative | 1300 | 25 | X | 12 |
| Example 4 | | | | |
| Comparative | 980 | 30 | X | 9 |
| Example 5 | | | | |
| Comparative | 860 | 25 | X | 11 |
| Example 6 | | | | |

Referring to Table 3, in Examples 1 to 3, the thicknesses of the first bonding layers were 460 nm, 510 nm and 570 nm, respectively, and the thicknesses of the second bonding layers were 210 nm, 330 nm, 320 nm, all of which ranged from 50 to 800 nm. All of the examples showed excellent sealing characteristics in the sealability evaluation and excellent bonding strength values greater than 40 MPa.

On the other hand, the thickness of the first bonding layer in Comparative Examples 1 and 3 to 6, except for Comparative Example 2, all exceeded 800 nm. In the case of the second bonding layer thickness, all of Comparative Examples 2 to 5, except for Comparative Example 1, showed small values of less than 50 nm. That is, none of the specimens in Comparative Examples 1 to 6 had both the first and second bonding layers within the thickness range of 50 to 800 nm.

Accordingly, all of Comparative Examples 1 to 6 did not show the sealing effect in the sealability evaluation, and showed low bonding strength values less than 40 MPa.

In the case of Comparative Examples 1 and 3, the solutions for electrolytic oxidation were acidic solution mixtures prepared by mixing oxalic acid, phosphoric acid and sulfuric acid, but the composition of the total acid components in the acidic solution mixtures exceeded 35 wt %. In the case of Comparative Example 2, the solution for electroless oxidation was a mixed solution prepared by dissolving sodium hydroxide, sodium chlorite and sodium phosphate, but the composition of the total materials in the mixed solution exceeded 50 wt %. Accordingly, it can be seen that it is difficult to secure excellent bonding strength between the metal laminate and the polymer resin when the concentration of the acid components constituting the solution for electrolytic oxidation or the concentration of the substances constituting the solution for electroless oxidation is too high.

Referring to Examples 1 to 3 and Comparative Examples 4 to 6, it can be confirmed that when the solution for electrolytic oxidation is prepared by mixing two or more acids, and the solution for electroless oxidation is prepared by mixing two or more substances, the bonding strength between the metal laminate and the polymer resin is superior to when the solutions are prepared by mixing only one acid or one substance.

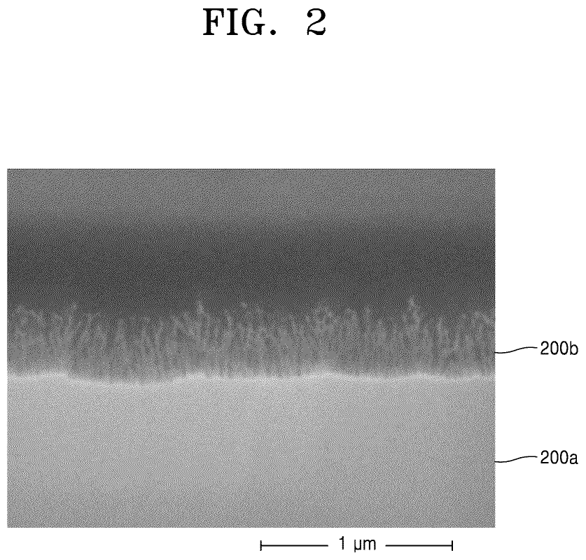

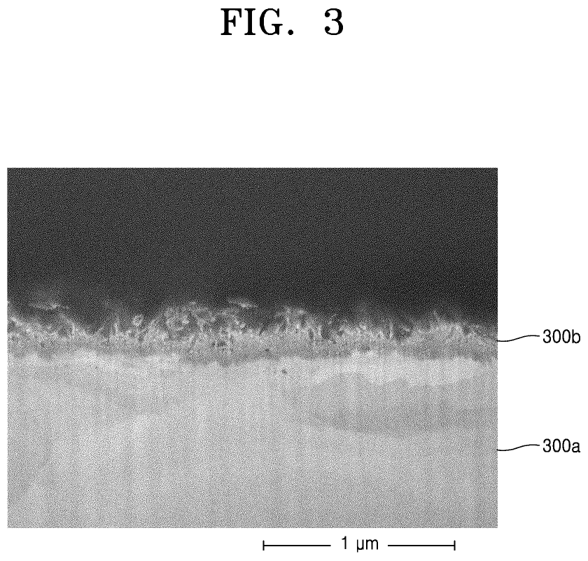

FIGS. 2 and 3 illustrate the cross-section of the surface of metal laminate of Example 1 observed using an electron microscope. FIG. 2 illustrates the cross-section of the aluminum surface, and FIG. 3 illustrates the cross-section of the copper surface. In FIG. 2, reference numerals (200a) and (200b) indicate aluminum and the oxide film formed on the surface of the aluminum, respectively. In FIG. 3, reference numerals (300a) and (300b) indicate copper and the oxide film formed on the surface of the copper, respectively.

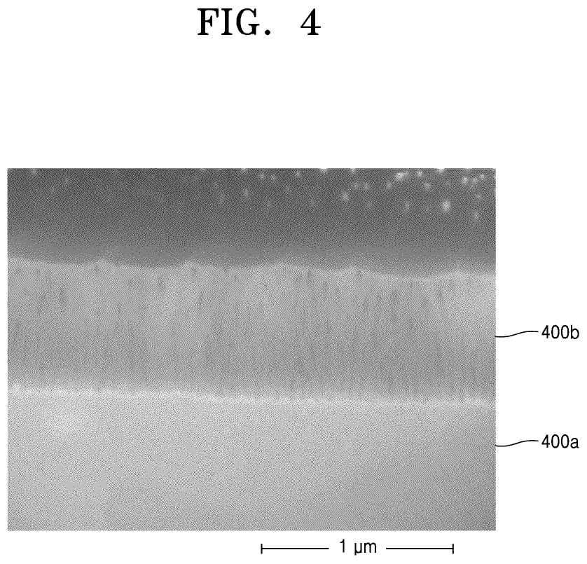

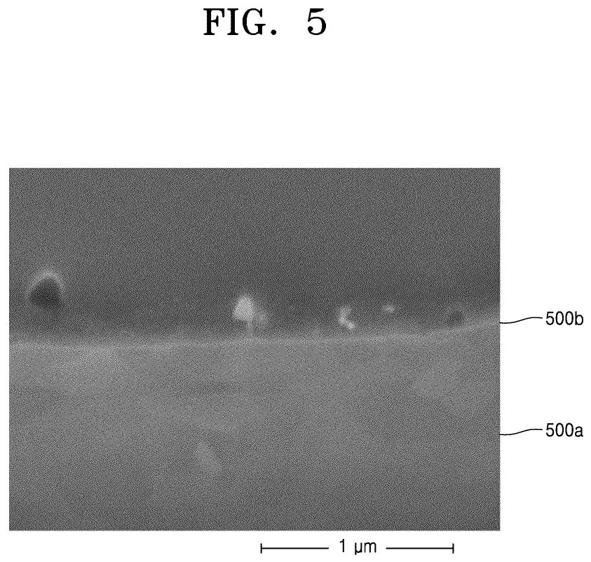

FIGS. 4 and 5 illustrates the cross-section of the surface of metal laminate of Comparative Example 6 observed using an electron microscope. FIG. 4 illustrates the cross-section of the aluminum surface, and FIG. 5 illustrates the cross-section of the copper surface. In FIG. 4, reference numerals (400a) and (400b) indicate aluminum and the oxide film formed on the surface of the aluminum, respectively. In FIG. 5, reference numerals (500a) and (500b) indicate copper and the oxide film formed on the surface of the copper, respectively.

Referring to FIGS. 2 and 3, it can be seen that, in the case of Example 1, a porous oxide film (200b, 300b) having a fine roughened structure is formed on both the aluminum surface and the copper surface, thereby creating a very rough surface. On the other hand, it can be confirmed from FIGS. 4 and 5 that, in the case of Comparative Example 6, both the aluminum surface and the copper surface form a dense and relatively flat oxide layer (400b, 500b) with no pores, no irregularities, and low roughness. It can be confirmed that the difference in bonding force between the metal laminate and the polymer resin is caused by the difference in the microstructures of the first and second oxide layers of Example 1 and Comparative Example 6.

In accordance with a method of surface-treating a metal laminate according to the technical idea of the present disclosure, a metal laminate-polymer resin composite in which the bonding strength between the metal laminate and the polymer resin is excellent can be manufactured. The effects of the present disclosure described above are described as examples, and the scope of the present disclosure is not limited by these effects.

It will be obvious to those skilled in the art, to which the technical idea of the disclosure pertains, that the technical idea of the disclosure described above is not limited to the above-described embodiments and the accompanying drawings and various substitutions, modifications, and changes are possible within the scope of the technical idea of the disclosure.

What is claimed is:

1. A method of preparing a metal laminate-polymer resin composite, the metal laminate-polymer resin composite comprising: a metal laminate formed of copper and aluminum laminated therein; and a polymer resin,
the method comprising:
a degreasing step of degreasing a surface of the metal laminate;
an electrolytic oxidation step of electrolytically oxidizing the metal laminate in a solution for electrolytic oxidation to form a first porous oxide film having a roughened structure on a surface of the aluminum;
an electroless oxidation step of performing electroless oxidation for the metal laminate in a solution for electroless oxidation to form a second porous oxide film having a roughened structure on a surface of the copper; and
a bonding step of bonding the metal laminate with the polymer resin,
wherein the solution for electrolytic oxidation is an acidic solution prepared by mixing two or more acids selected from oxalic acid (C₂H₂O₄), phosphoric acid (H₃PO₄), chromic acid (H₂CrO₄), citric acid (CH₈O₇) and sulfuric acid (H₂SO₄) with water, and
the solution for electroless oxidation is a mixed solution prepared by dissolving two or more substances selected from sodium sulfate, sodium hydroxide, sodium chlorate, sodium chlorite and sodium phosphate in water.

2. The method according to claim 1, wherein a sum of the concentrations of the two or more acids comprised in the solution for electrolytic oxidation is 1 to 35 wt %.

3. The method according to claim 1, wherein a concentration of each of the two or more acids comprised in the solution for electrolytic oxidation is 1 wt % or more and less than 20 wt %.

4. The method according to claim 1, wherein the first oxide film has a thickness of 50 to 800 nm.

5. The method according to claim 1, wherein a sum of concentrations of the two or more substances contained in the solution for electroless oxidation is 1 to 50 wt %.

6. The method according to claim 1, wherein a concentration of each of the two or more substances contained in the solution for electroless oxidation is 1 wt % or more and less than 30 wt %.

7. The method according to claim 1, wherein the second oxide film has a thickness of 50 to 800 nm.

8. The method according to claim 1, wherein, in the electrolytic oxidation step, a current density applied to the metal laminate, which is a positive electrode, is 0.5 to 50 A/dm².

9. The method according to claim 1, wherein, in the electrolytic oxidation step, the solution for electrolytic oxidation has a temperature of 20 to 80° C.

10. The method according to claim 1, wherein, in the electroless oxidation step, the solution for electroless oxidation has a temperature of 20 to 80° C.

11. The method according to claim 1, wherein the polymer resin comprises one of polyphenylene sulfide, polybutylene terephthalate, liquid crystal polymers, polyether ether ketone, polyphthalamide, polyamide, polycarbonate and polypropylene.

12. The method according to claim 1, wherein, in the degreasing step, a degreasing solution comprises ionic water.

13. A metal laminate-polymer resin composite, comprising:
a metal laminate formed of copper and aluminum laminated therein; and
a polymer resin bonded to at least a part of the copper and at least a part of the aluminum,
wherein a first porous oxide film having a roughened structure is formed on a surface of the aluminum bonded to the polymer resin, and
a second porous oxide film having a roughened structure is formed on a surface of the copper bonded to the polymer resin.

14. The metal laminate-polymer resin composite according to claim 13, wherein the first oxide film has a thickness of 50 to 800 nm.

15. The metal laminate-polymer resin composite according to claim 13, wherein the second oxide film has a thickness of 50 to 800 nm.

16. The metal laminate-polymer resin composite according to claim 13, wherein a bonding strength between the metal laminate and the polymer resin is 40 MPa or more.

17. The metal laminate-polymer resin composite according to claim 13, wherein the polymer resin comprises one of polyphenylene sulfide, polybutylene terephthalate, liquid crystal polymers, polyether ether ketone, polyphthalamide, polyamide, polycarbonate and polypropylene.
